(19) United States
(12) Patent Application Publication
(10) Pub. No.: US 2024/0312119 A1
(43) Pub. Date: Sep. 19, 2024

(54) SYSTEMS AND METHODS FOR IMAGE RECONSTRUCTION

(71) Applicant: SHANGHAI UNITED IMAGING HEALTHCARE CO., LTD., Shanghai (CN)

(72) Inventors: Yang HU, Shanghai (CN); Le YANG, Shanghai (CN); Na ZHANG, Shanghai (CN)

(73) Assignee: SHANGHAI UNITED IMAGING HEALTHCARE CO., LTD., Shanghai (CN)

(21) Appl. No.: 18/675,181

(22) Filed: May 28, 2024

Related U.S. Application Data
(63) Continuation of application No. PCT/CN2022/142893, filed on Dec. 28, 2022.

(30) Foreign Application Priority Data
Dec. 31, 2021 (CN) 202111674386.0

(51) Int. Cl. G06T 15/08; G06T 19/00

(52) U.S. Cl. CPC G06T 15/08; G06T 19/00; G06T 2210/41; G06T 2219/004

(57) ABSTRACT

The present disclosure relates to systems and methods for image reconstruction. The systems may obtain one or more projection images of an object and a first reconstruction image corresponding to the one or more projection images. The systems may determine, for each of the one or more projection images, an initial range of a target region on the projection image based on the first reconstruction image. The target region may be a low-gray region generated on the projection image by a substance with an X-ray attenuation coefficient greater than a predetermined threshold. The systems may determine, within the initial range, the target region on the projection image. The systems may generate a three-dimensional (3D) image of the object based at least on target regions corresponding to the one or more projection images.

### CROSS-REFERENCE TO RELATED APPLICATIONS

This application is a continuation of International Application No. PCT/CN2022/142893, filed on Dec. 28, 2022, which claims priority of Chinese Patent Application No. 202111674386.0 filed on Dec. 31, 2021, the contents of which are incorporated herein by reference.

### TECHNICAL FIELD

The present disclosure generally relates to the field of imaging technology, and in particular, to systems and methods for image reconstruction.

### BACKGROUND

A tomography (TOMO) system, such as a digital breast tomography (DBT) system, a digital radiography tomography (DR TOMO) system, etc., is a new type of system that utilizes limited-angle computed tomography to present three-dimensional information of an object. Compared with a conventional two-dimensional imaging device, the TOMO system, as a relatively new image acquisition technology in recent years, can effectively increase the diagnostic sensitivity for lesion sites and reduce there-examination frequency of patients without significantly increasing the dose received by the patients. However, due to the limited angle at which imaging data was acquired, various artifacts of high attenuated substances (e.g., metals) are often present in reconstruction images obtained by the TOMO system, resulting in poor quality of the reconstruction images, thereby affecting the patient's diagnosis. Therefore, it is desirable to provide systems and methods for image reconstruction to remove or reduce the artifacts and improve the quality of the reconstruction images.

### SUMMARY

An aspect of the present disclosure relates to a system for image reconstruction. The system may include at least one storage device including a set of instructions and at least one processor in communication with the at least one storage device. When executing the set of instructions, the at least one processor may be directed to cause the system to implement operations. The operations may include obtaining one or more projection images of an object and a first reconstruction image corresponding to the one or more projection images; for each of the one or more projection images. The operations may include determining an initial range of a target region on the projection image based on the first reconstruction image. The target region may be a low-gray region generated on the projection image by a substance with an X-ray attenuation coefficient greater than a predetermined threshold. The operations may include determining, within the initial range, the target region on the projection image and generating a three-dimensional (3D) image of the object based at least on target regions corresponding to the one or more projection images.

In some embodiments, the determining the initial range of the target region on the projection image based on the first reconstruction image may include generating a maximum density projection image of the first reconstruction image by performing, along a predetermined direction, a maximum density projection on the first reconstruction image; and determining the initial range of the target region on the projection image based on the maximum density projection image.

In some embodiments, the determining the initial range of the target region on the projection image based on the maximum density projection image may include generating an index image of the maximum density projection image in the predetermined direction based on the first reconstruction image, the index image including index values, the index values indicating positions, on the first reconstruction image, of pixels on the maximum density projection image; generating a binarized image based on the maximum density projection image; and determining the initial range of the target region on the projection image based on the binarized image and the index image.

In some embodiments, the generating the binarized image based on the maximum density projection image may include generating the binarized image based on a grayscale threshold and the maximum density projection image.

In some embodiments, the generating the binarized image based on the maximum density projection image may include generating a relative gradient image of the maximum density projection image and generating the binarized image based on a gradient threshold and the relative gradient image.

In some embodiments, the generating the binarized image based on the gradient threshold and the relative gradient image may include generating an initial binarized image based on a grayscale threshold and the maximum density projection image and generating the binarized image by updating the initial binarized image based on the gradient threshold and the relative gradient image.

In some embodiments, the determining the initial range of the target region on the projection image based on the binarized image and the index image may include obtaining one or more pixel clusters corresponding to the target region based on the binarized image through region growth; for each of the one or more pixel clusters, labeling voxels in the first reconstruction image corresponding to the pixel cluster based on the pixel cluster and the index image; and determining the initial range of the target region on the projection image based on voxels in the first reconstruction image corresponding to the one or more pixel clusters.

In some embodiments, for each of the one or more pixel clusters, the labeling the voxels in the first reconstruction image corresponding to the pixel cluster based on the pixel cluster and the index image may include performing a histogram statistic on index values in the index image corresponding to pixels in the pixel cluster; obtaining an index value range corresponding to the pixels of the pixel cluster based on the histogram statistic; and labeling the voxels in the first reconstruction image corresponding to the pixel cluster based on the index value range.

In some embodiments, the determining the initial range of the target region on the projection image based on the voxels in the first reconstruction image corresponding to the one or more pixel clusters may include obtaining the initial range of the target region on the projection image by projecting the voxels in the first reconstruction image corresponding to the one or more pixel clusters on the projection image along an incident direction of rays associated with the obtaining of the projection image.

In some embodiments, the operations may further include processing the projection image by removing the target region from the projection image. The generating the 3D image of the object based at least on the target regions corresponding to the one or more projection images may include generating the 3D image of the object based on the target regions corresponding to the one or more projection images and one or more processed projection images or the one or more projection images.

In some embodiments, the generating the 3D image of the object based on the target regions corresponding to the one or more projection images and the at least one of the one or more processed projection images or the one or more projection images may include determining a second reconstruction image by reconstructing the target regions corresponding to the one or more projection images; for each of the one or more processed projection images, interpolating a region on the processed projection image corresponding to the target region; determining a third reconstruction image by reconstructing one or more interpolated projection images; and generating the 3D image of the object based on the second reconstruction image and the third reconstruction image or the one or more projection images.

In some embodiments, the one or more projection images are obtained by a digital breast tomosynthesis device.

A further aspect of the present disclosure relates to a method for image reconstruction. The method may be implemented on a computing device including at least one processor, at least one storage medium, and a communication platform connected to a network. The method may include obtaining one or more projection images of an object and a first reconstruction image corresponding to the one or more projection images. The method may include determining, for each of the one or more projection images, an initial range of a target region on the projection image based on the first reconstruction image. The target region may be a low-gray region generated on the projection image by a substance with an X-ray attenuation coefficient greater than a predetermined threshold. The method may include determining, within the initial range, the target region on the projection image and generating a three-dimensional (3D) image of the object based at least on target regions corresponding to the one or more projection images.

A still further aspect of the present disclosure relates to a system for image reconstruction. The system may include an obtaining module, a first determination module, a second determination module, and a generation module. The obtaining module may be configured to obtain one or more projection images of an object and a first reconstruction image corresponding to the one or more projection images. The first determination module may be configured to determine, for each of the one or more projection images, an initial range of a target region on the projection image based on the first reconstruction image. The target region may be a low-gray region generated on the projection image by a substance with an X-ray attenuation coefficient greater than a predetermined threshold. The second determination module may be configured to determine, within the initial range, the target region on the projection image. The generation module may be configured to generating a three-dimensional (3D) image of the object based at least on target regions corresponding to the one or more projection images.

A still further aspect of the present disclosure relates to a non-transitory computer readable medium including executable instructions. When the executable instructions are executed by at least one processor, the executable instructions may direct the at least one processor to perform a method. The method may include obtaining one or more projection images of an object and a first reconstruction image corresponding to the one or more projection images. The method may include determining, for each of the one or more projection images, an initial range of a target region on the projection image based on the first reconstruction image. The target region may be a low-gray region generated on the projection image by a substance with an X-ray attenuation coefficient greater than a predetermined threshold. The method may include determining, within the initial range, the target region on the projection image and generating a three-dimensional (3D) image of the object based at least on target regions corresponding to the one or more projection images.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary imaging system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device according to some embodiments of the present disclosure;

FIG. 4 is a schematic diagram illustrating an exemplary digital breast tomography (DBT) device according to some embodiments of the present disclosure;

FIG. 5A is a schematic diagram illustrating exemplary in-plane artifacts according to some embodiments of the present disclosure;

FIG. 5B is a schematic diagram illustrating exemplary out-of-plane artifacts according to some embodiments of the present disclosure;

FIG. 6 is a block diagram illustrating an exemplary processing device according to some embodiments of the present disclosure;

FIG. 7 is a flowchart illustrating an exemplary process for image reconstruction according to some embodiments of the present disclosure;

FIG. 8 is a flowchart illustrating an exemplary process for determining an initial

range of a target region on a projection image according to some embodiments of the present disclosure;

FIG. 9 is a flowchart illustrating an exemplary process for determining an initial range of a target region on a projection image according to some embodiments of the present disclosure; and

FIG. 10 is a flowchart illustrating an exemplary process for determining an initial range of a target region on a projection image according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

It will be understood that the terms “system,” “engine,” “unit,” “module,” and/or “block” used herein are one method to distinguish different components, elements, parts, sections, or assemblies of different levels in ascending order. However, the terms may be displaced by another expression if they achieve the same purpose.

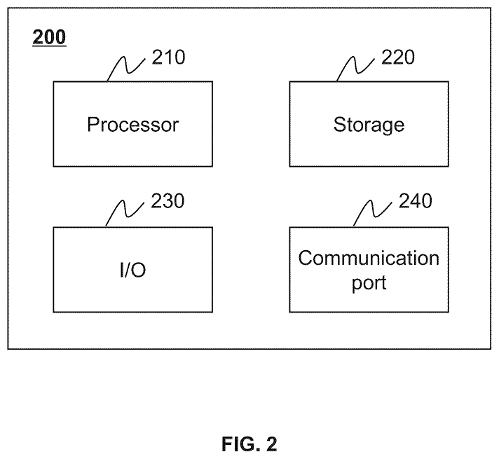

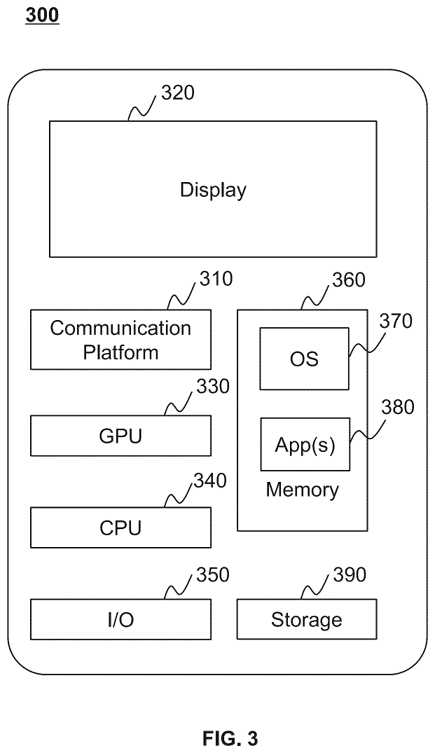

Generally, the words “module,” “unit,” or “block,” as used herein, refer to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 210 illustrated in FIG. 2 and/or the central processing unit (CPU) 340 illustrated in FIG. 3) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may apply to a system, an engine, or a portion thereof.

It will be understood that when a unit, engine, module, or block is referred to as being “on,” “connected to,” or “coupled to” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

The term “image” in the present disclosure is used to collectively refer to imaging data (e.g., scan data, projection data) and/or images of various forms, including a two-dimensional (2D) image, a three-dimensional (3D) image, a four-dimensional (4D), etc. The terms “pixel” and “voxel” in the present disclosure are used interchangeably to refer to an element of an image. The terms “region,” “location,” and “area” in the present disclosure may refer to a location of an anatomical structure shown in the image or an actual location of the anatomical structure existing in or on a target object's body, since the image may indicate the actual location of a certain anatomical structure existing in or on the target object's body.

Provided herein are systems and methods for non-invasive biomedical imaging/treatment, such as for disease diagnostic, disease therapy, or research purposes. In some embodiments, the systems may include an imaging system. The imaging system may include a single modality system and/or a multi-modality system. The term “modality” used herein broadly refers to an imaging or treatment method or technology that gathers, generates, processes, and/or analyzes imaging information of a subject or treatments the subject. The single modality system may include, for example, a digital breast tomography (DBT) system, a digital radiography tomography (DR TOMO) system, an X-ray imaging system, or the like, or any combination thereof. The multi-modality system may include, for example, an X-ray imaging-magnetic resonance imaging (X-ray-MRI) system, a positron emission tomography-X-ray imaging (PET-X-ray) system, etc. It should be noted that the imaging system described herein is merely provided for illustration purposes, and not intended to limit the scope of the present disclosure.

In the present disclosure, a representation of an object (e.g., a patient, a subject, or a portion thereof) in an image may be referred to as “object” for brevity. For instance, a representation of an organ or tissue (e.g., a heart, a liver, a lung) in an image may be referred to as an organ or tissue for brevity. Further, an image including a representation of an object may be referred to as an image of an object or an image including an object for brevity. Still further, an operation performed on a representation of an object in an image may be referred to as an operation performed on an object for brevity. For instance, a segmentation of a portion of an image including a representation of an organ or tissue from the image may be referred to as a segmentation of an organ or tissue for brevity.

An aspect of the present disclosure provides systems and methods for image reconstruction. The systems may obtain one or more projection images of an object (e.g., a breast) and a first reconstruction image corresponding to the one or more projection images. For each of the one or more projection images, the systems may determine an initial range of a target region on the projection image based on the first reconstruction image. The target region may be a low-gray region generated on the projection image by a substance (e.g., a metal implant, a calcification point, a calcification region) with an X-ray attenuation coefficient greater than a predetermined threshold. For example, the target region may be an artifact region generated on the projection image by the substance. Further, the systems may determine, within the initial range, the target region on the projection image and generate a three-dimensional (3D) image of the object based at least on target regions corresponding to the one or more projection images. For example, the systems may process the projection image by removing the target region from the projection image and generate the 3D image of the object based at least on one or more processed projection images. According to some embodiments of the systems and methods of the present disclosure, a coarse localization (i.e., the initial range) of an artifact region (i.e., the target region) may be determined based on the first reconstruction image. According to the coarse localization, the artifact region may be located on the projection image, which improves the accuracy of the localization of the artifact region on the projection image, thereby improving the removal effect of the artifact region from the projection image, accordingly, the quality of the generated 3D image of the object may be improved.

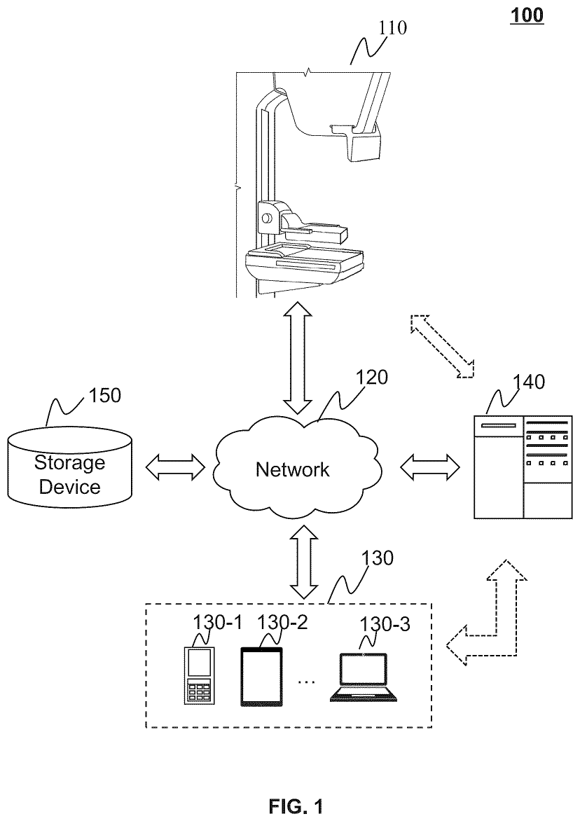

FIG. 1 is a schematic diagram illustrating an exemplary imaging system according to some embodiments of the present disclosure. As illustrated in FIG. 1, an imaging system 100 may include an imaging device 110, a network 120, one or more terminal devices 130, a processing device 140, and a storage device 150. In some embodiments, two or more components of the imaging system 100 may be connected to and/or communicate with each other in various ways, for example, a wireless connection (e.g., the network 120), a wired connection, or the like, or any combination thereof. Merely by way of example, the imaging device 110 may be connected to the processing device 140 through the network 120. As another example, the imaging device 110 may be connected to the processing device 140 directly as indicated by the bi-directional arrow in dotted lines linking the imaging device 110 and the processing device 140. As a further example, the storage device 150 may be connected to the processing device 140 directly or through the network 120. As still a further example, the one or more terminal devices 130 (e.g., terminals 130-1, 130-2, 130-3, etc.) may be connected to the processing device 140 directly (as indicated by the bi-directional arrow in dotted lines linking the one or more terminal devices 130 and the processing device 140) or through the network 120.

The imaging device 110 may be configured to acquire imaging data relating to an object or a portion thereof. The object may include a biological object and/or a non-biological object. The biological object may include a human being, an animal, a plant, or a specific portion, organ, and/or tissue thereof. For example, the object may include a head, a neck, a thorax, a heart, a stomach, a blood vessel, a soft tissue, a tumor, a nodule, a nodule, a chest, an abdomen, a breast, an intestine, or the like, or any combination thereof. In some embodiments, the object may include a man-made composition of organic and/or inorganic matters that are with or without life. In the present disclosure, the term “object” or “subject” is used interchangeably. The imaging device 110 may scan the object or a portion thereof that is located within its detection region and generate the imaging data relating to the object or the portion thereof. In some embodiments, the imaging data relating to the object or the portion thereof may include projection images, projection data, or the like, or any combination thereof. In some embodiments, the imaging device 110 may include a DBT device, a DR TOMO device, or the like, or any combination thereof. More descriptions regarding the DBT device may be found elsewhere in the present disclosure (e.g., FIG. 4 and the description thereof).

The network 120 may facilitate exchange of information and/or data. In some embodiments, the network 120 may be any type of wired or wireless network, or a combination thereof. Merely by way of example, the network 120 may include a hospital information system (HIS), a picture archiving and communication system (PACS), or other networks connected thereto although independent of the HIS or PACS. In some embodiments, one or more components (e.g., the imaging device 110, the one or more terminal devices 130, the processing device 140, the storage device 150) of the imaging system 100 may send information and/or data to other component(s) of the imaging system 100 via the network 120. For example, the processing device 140 may obtain, via the network 120, the imaging data relating to the object or a portion thereof from the imaging device 110. As another example, the processing device 140 may obtain an instruction of a user (e.g., a doctor, a radiologist) from the terminal 130 via the network 120. In some embodiments, the network 120 may include one or more network access points. For example, the network 120 may include wired or wireless network access points such as base stations and/or internet exchange points through which one or more components of the imaging system 100 may be connected to the network 120 to exchange data and/or information.

The one or more terminal devices 130 may enable an interaction between the user and the imaging system 100. In some embodiments, the one or more terminal devices 130 may connect and/or communicate with the one or more components (e.g., the imaging device 110, the processing device 140, the storage device 150) of the imaging system 100. For example, the one or more terminal devices 130 may obtain, from the processing device 140, a processing result, e.g., a 3D image of the object. As another example, the one or more terminal devices 130 may display the processing result obtained from the processing device 140. As a further example, the user (e.g., the doctor, the radiologist) may send one or more instructions to the imaging device 110 through the one or more terminal devices 130 to control the imaging device 110 to scan the object according to the instructions. In some embodiments, the one or more terminal devices 130 may remotely operate the imaging device 110. In some embodiments, the one or more terminal devices 130 may operate the imaging device 110 via a wireless connection. In some embodiments, the one or more terminal devices 130 may receive information and/or instructions inputted by the user, and send the received information and/or instructions to the imaging device 110 or the processing device 140 via the network 120. In some embodiments, the one or more terminal devices 130 may receive data and/or information from the processing device 140. In some embodiments, the one or more terminal devices 130 may include a mobile device 130-1, a tablet computer 130-2, a laptop computer 130-3, or the like, or any combination thereof. In some embodiments, the mobile device 130-1 may include a smart home device, a wearable device, a smart mobile device, a virtual reality device, an augmented reality device, or the like, or any combination thereof. In some embodiments, the one or more terminal devices 130 may be part of the processing device 140. In some embodiments, the one or more terminal devices 130 may be omitted.

The processing device 140 may process data and/or information obtained from the imaging device 110, the one or more terminal devices 130, and/or the storage device 150. For example, the processing device 140 may obtain one or more projection images of an object (e.g., a breast) and a first reconstruction image corresponding to the one or more projection images. For each of the one or more projection images, the processing device 140 may determine an initial range of a target region on the projection image based on the first reconstruction image. Further, the processing device 140 may determine, within the initial range, the target region on the projection image and generate a 3D image of the object based at least on target regions corresponding to the one or more projection images. In some embodiments, the processing device 140 may be a central processing unit (CPU), a digital signal processor (DSP), a system on a chip (SoC), a microcontroller unit (MCU), or the like, or any combination thereof. In some embodiments, the processing device 140 may be a single server or a server group. The server group may be centralized or distributed. In some embodiments, the processing device 140 may be local or remote. For example, the processing device 140 may access information and/or data stored in the imaging device 110, the one or more terminal devices 130, and/or the storage device 150 via the network 120. As another example, the processing device 140 may be directly connected to the imaging device 110, the one or more terminal devices 130, and/or the storage device 150, to access stored information and/or data. In some embodiments, the processing device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

The storage device 150 may store data (the one or more projection images of the object, the first reconstruction image, the 3D image of the object), instructions, and/or other information. In some embodiments, the storage device 150 may store data obtained from the imaging device 110, the one or more terminal devices 130, and/or the processing device 140. For example, the storage device 150 may store the one or more projection images of the object obtained from the imaging device 110. In some embodiments, the storage device 150 may store data and/or instructions that the processing device 140 may execute or use to perform exemplary methods described in the present disclosure. In some embodiments, the storage device 150 may include a mass storage, removable storage, a volatile read-and-write memory, a read-only memory (ROM), or the like, or any combination thereof. In some embodiments, the storage device 150 may be implemented on the cloud platform described elsewhere in the present disclosure. In some embodiments, the storage device 150 may be connected to the network 120 to communicate with one or more components (e.g., the imaging device 110, the one or more terminal devices 130, the processing device 140) of the imaging system 100. One or more components of the imaging system 100 may access the data or instructions stored in the storage device 150 via the network 120. In some embodiments, the storage device 150 may be directly connected to or communicate with one or more components (e.g., the imaging device 110, the one or more terminal devices 130, the processing device 140) of the imaging system 100. In some embodiments, the storage device 150 may be part of the processing device 140.

It should be noted that the above description of the imaging system 100 is merely provided for the purposes of illustration, and not intended to limit the scope of the present disclosure. For persons having ordinary skills in the art, multiple variations and modifications may be made under the teachings of the present disclosure. For example, the imaging system 100 may include one or more additional components and/or one or more components of the imaging system 100 described above may be omitted. Additionally or alternatively, two or more components of the imaging system 100 may be integrated into a single component. A component of the imaging system 100 may be implemented on two or more sub-components. However, those variations and modifications do not depart from the scope of the present disclosure.

FIG. 2 is a schematic diagram illustrating exemplary hardware and/or software components of an exemplary computing device according to some embodiments of the present disclosure. The computing device 200 may be used to implement any component of the imaging system 100 as described herein. For example, the processing device 140 and/or the one or more terminal devices 130 may be implemented on the computing device 200, respectively, via its hardware, software program, firmware, or a combination thereof. Although only one such computing device is shown, for convenience, the computer functions relating to the imaging system 100 as described herein may be implemented in a distributed fashion on a number of similar platforms, to distribute the processing load. As illustrated in FIG. 2, the computing device 200 may include a processor 210, a storage 220, an input/output (I/O) 230, and a communication port 240.

The processor 210 may execute computer instructions (e.g., program codes) and perform functions of the processing device 140 in accordance with techniques described herein. The computer instructions may include, for example, routines, programs, objects, components, data structures, procedures, modules, and functions, which perform particular functions described herein. For example, the processor 210 may obtain one or more projection images of an object (e.g., a breast) and a first reconstruction image corresponding to the one or more projection images. For each of the one or more projection images, the processor 210 may determine an initial range of a target region on the projection image based on the first reconstruction image. Further, the processor 210 may determine, within the initial range, the target region on the projection image and generate a 3D image of the object based at least on target regions corresponding to the one or more projection images. In some embodiments, the processor 210 may include one or more hardware processors, such as a microcontroller, a microprocessor, a reduced instruction set computer (RISC), an application-specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or a combinations thereof.

Merely for illustration, only one processor is described in the computing device 200. However, it should be noted that the computing device 200 in the present disclosure may also include multiple processors. Thus, operations and/or method steps that are performed by one processor as described in the present disclosure may also be jointly or separately performed by the multiple processors. For example, if in the present disclosure the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage 220 may store data/information obtained from the imaging device 110, the storage device 150, the one or more terminal devices 130, and/or any other component of the imaging system 100. In some embodiments, the storage 220 may include a mass storage device, a removable storage device, a volatile read-and-write memory, a read-only memory (ROM), or the like, or a combination thereof. In some embodiments, the storage 220 may store one or more programs and/or instructions to perform exemplary methods described in the present disclosure.

The I/O 230 may input and/or output signals, data, information, etc. In some embodiments, the I/O 230 may enable a user interaction with the processing device 140. In some embodiments, the I/O 230 may include an input device and an output device. The input device may include alphanumeric and other keys that may be input via a keyboard, a touch screen (for example, with haptics or tactile feedback), a speech input, an eye-tracking input, a brain monitoring system, or any other comparable input mechanism. The input information received through the input device may be transmitted to another component (e.g., the processing device 140) via, for example, a bus, for further processing. Other types of the input device may include a cursor control device, such as a mouse, a trackball, cursor direction keys, etc. The output device may include a display (e.g., a liquid crystal display (LCD), a light-emitting diode (LED)-based display, a flat panel display, a curved screen, a television device, a cathode ray tube (CRT), a touch screen), a speaker, a printer, or the like, or a combination thereof.

The communication port 240 may be connected to a network (e.g., the network 140) to facilitate data communications. The communication port 240 may establish connections between the processing device 140 and one or more components (e.g., the imaging device 110, the storage device 150, and/or the one or more terminal devices 130) of the imaging system 100. The connection may be a wired connection, a wireless connection, any other communication connection that can enable data transmission and/or reception, and/or a combination of these connections. The wired connection may include, for example, an electrical cable, an optical cable, a telephone wire, or the like, or a combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc. In some embodiments, the communication port 240 may be a specially designed communication port. For example, the communication port 240 may be designed in accordance with the digital imaging and communications in medicine (DICOM) protocol.

FIG. 3 is a schematic diagram illustrating exemplary hardware and/or software components of an exemplary mobile device according to some embodiments of the present disclosure. In some embodiments, one or more components (e.g., the one or more terminal devices 130, the processing device 140) of the imaging system 100 may be implemented on one or more components of the mobile device 300.

As illustrated in FIG. 3, the mobile device 300 may include a communication platform 310, a display 320, a graphics processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to the imaging system 100. User interactions with the information stream may be achieved via the I/O 350 and provided to the processing device 140 and/or other components of the imaging system 100 via the network 140.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to generate an image as described herein. A computer with user interface elements may be used to implement a personal computer (PC) or another type of work station or terminal device, although a computer may also act as a server if appropriately programmed. It is believed that those skilled in the art are familiar with the structure, programming and general operation of such computer equipment and as a result, the drawings should be self-explanatory.

FIG. 4 is a schematic diagram illustrating an exemplary DBT device according to some embodiments of the present disclosure. As shown in FIG. 4, the DBT device 400 may include a radiation source 410, a compression plate 420, a detector 430, and a gantry 440. In some embodiments, the radiation source 410, the compression plate 420, and the detector 430 may be mounted on the gantry 440.

The radiation source 410 may emit radiation rays to an object within a certain angle range. For example, as shown in FIG. 4, the radiation source 410 may move within an angle range (e.g., 15°-60°) and emit radiation rays to the object at any one angle within the angle range. Merely by way of example, as shown in FIG. 4, the object may be a breast, and the radiation source 410 may emit radiation rays to the breast at an angle A, an angle B, and an angle C. In some embodiments, the radiation rays may be X-rays. In some embodiments, as shown in FIG. 4, the radiation rays may be radiation beams. The compression plate 420 may be configured to immobilize the object, for example, the breast. As shown in FIG. 4, the compression plate 420 may compress the breast on the detector 430. The detector 430 may be configured to detect radiation rays (e.g., the X-rays) emitted from an imaging region (e.g., a region between the compression plate 420 and the detector 430) of the DBT device 400.

The detector 430 may convert the detected radiation rays into digital signals and output the digital signals to, for example, a processor (e.g., the processing device 140) for processing or a storage device (e.g., the storage device 150, the storage 220, and/or the storage 390) for storage. Further, the processing device 140 may generate one or more projection images of the object (e.g., the breast) based on the digital signals output by the detector 430. For example, the processing device 140 may generate a projection image of the object corresponding to each angle (e.g., the angle A, the angle B, and the angle C). Further, the processing device 140 may generate a first reconstruction image of the object by reconstructing the one or more projection images. The first reconstruction image may be a 3D image including a plurality of image layers. The 3D image may reflect 3D information of the object, such as 3D coordinates of the object.

For illustrative purposes, a coordinate system 450 is provided in FIG. 4. The coordinate system 450 may include an X-axis, a Y-axis, and a Z-axis. As shown in FIG. 4, the X-axis and the Y-axis may be horizontal, and the Z-axis may be vertical. As shown in FIG. 4, when viewed from a direction facing the DBT device 400, a positive Z-direction along the Z axis may be a direction from the bottom to the top of the DBT device 400; a positive Y-direction of the Y axis may be a direction from the left to the right of the detector 430; a positive X-direction along the X axis may be a direction from in-screen to out-of-screen. Merely by way of example, the plurality of image layers in the first reconstruction image may be parallel to a plane in which the X and Y axes lie and superimposed along the Z axis. Each voxel in the first reconstruction image may have a 3D coordinate relative to the coordinate system 450.

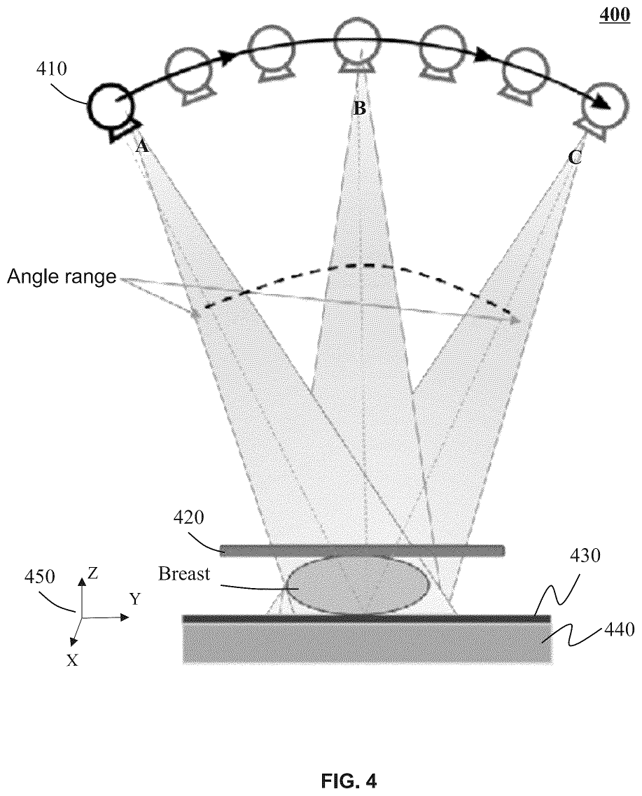

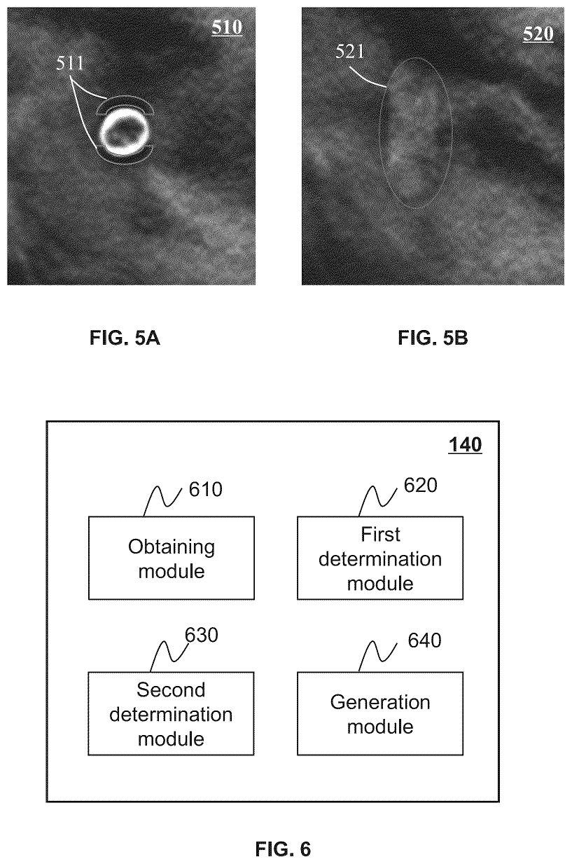

In some embodiments, the object (e.g., the breast) may include a substance (also referred to as a high attenuated substance) with an X-ray attenuation coefficient greater than a predetermined threshold, for example, a metal implant or a lesion (e.g., a calcification point, a calcification region). Since an absorption coefficient of radiation rays (e.g., X-rays) by the high attenuated substance is larger than that of normal human tissues, when the radiation rays passe through the human tissues (e.g., the breast) containing the high attenuated substance, the high attenuated substance may cause a relatively large attenuation of the radiation rays, so that a count of photons of the radiation rays that reach the detector 430 may be relatively small, which results in that attenuation values of all voxels corresponding to paths of the radiation rays that pass through the high attenuated substance may be incorrectly estimated during subsequent image reconstruction. As a result, artifacts (e.g., metal artifacts, calcification artifacts) of the high attenuated substance may be produced in the reconstruction image. The artifacts of the high attenuated substance may include in-plane artifacts and out-of-plane artifacts. The in-plane artifacts may refer to artifacts in an image layer (also referred to as a focused layer) in the reconstruction image where the high attenuated substance is located. FIG. 5A is a schematic diagram illustrating exemplary in-plane artifacts according to some embodiments of the present disclosure. As shown in FIG. 5A, an image layer 510 may be a focused layer, and artifacts 511 may be in-plane artifacts in the focused layer. The out-of-plane artifacts may refer to artifacts in image layers (also referred to as unfocused layers) in the reconstruction image other than the image layer where the high attenuated substance is located. FIG. 5B is a schematic diagram illustrating an exemplary out-of-plane artifact according to some embodiments of the present disclosure. As shown in FIG. 5B, an image layer 520 may be an unfocused layer, and artifact 521 may be an out-of-plane artifact in the unfocused layer.

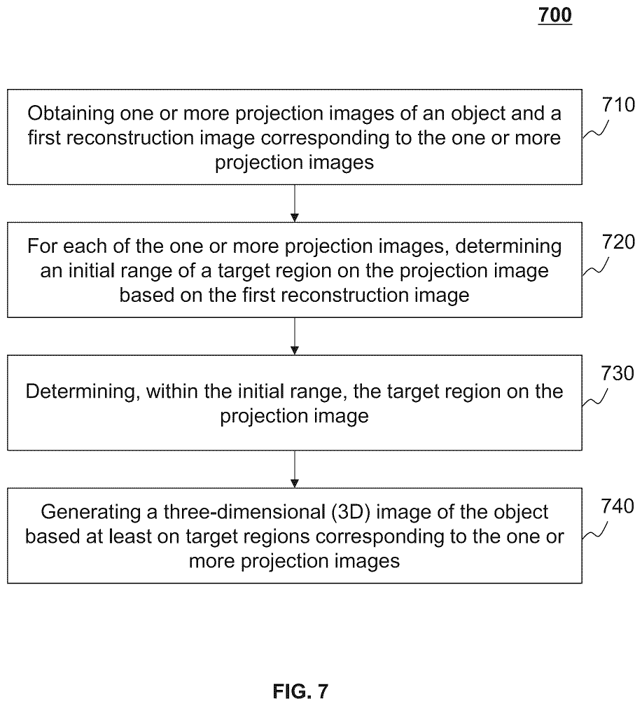

In addition, since a TOMO system (e.g., the DBT device 400) has fewer projection angles than other imaging systems (e.g., a computed tomography (CT) system), it is difficult for the attenuation values of the voxels that are incorrectly estimated to be compensated by a relatively large number of projection images from other angles. Therefore, artifacts of the high attenuated substance in images obtained by the TOMO system may be stronger than that in images obtained by the other imaging systems. Accordingly, in order to improve the quality of the images obtained by the TOMO system and the diagnostic accuracy of diseased tissues, it is desirable to remove or reduce the artifacts of the high attenuated substance from the images obtained by the TOMO system. Therefore, the embodiments of the present disclosure provide a method for image reconstruction to remove or reduce the artifacts of the high attenuated substance from the images obtained by the TOMO system. More descriptions regarding the method or process for image reconstruction may be found elsewhere in the present disclosure (e.g., FIG. 7 and the description thereof).

It should be noted that the above description of the DBT device 400 is merely provided for the purposes of illustration, and not intended to limit the scope of the present disclosure. For persons having ordinary skills in the art, multiple variations and modifications may be made under the teachings of the present disclosure. For example, the radiation source 410 may emit radiation rays to the breast at angles other than the angle A, the angle B, and the angle C. However, those variations and modifications do not depart from the scope of the present disclosure.

FIG. 6 is a block diagram illustrating an exemplary processing device according to some embodiments of the present disclosure. The processing device 140 may be implemented on the computing device 200 (e.g., the processor 210) illustrated in FIG. 2 or the mobile device 300 illustrated in FIG. 3. The processing device 140 may include an obtaining module 610, a first determination module 620, a second determination module 630, and a generation module 640.

The obtaining module 610 may be configured to obtain one or more projection images of an object and a first reconstruction image corresponding to the one or more projection images. More descriptions regarding the obtaining of the one or more projection images and the first reconstruction image may be found elsewhere in the present disclosure, for example, operation 710 and the descriptions thereof.

The first determination module 620 may be configured to determine, for each of the one or more projection images, an initial range of a target region on the projection image based on the first reconstruction image. More descriptions regarding the determination of the initial range of the target region on the projection image may be found elsewhere in the present disclosure, for example, operation 720 and the descriptions thereof.

The second determination module 630 may be configured to determine, within the initial range, the target region on the projection image. More descriptions regarding the determination of the target region on the projection image may be found elsewhere in the present disclosure, for example, operation 730 and the descriptions thereof.

The generation module 640 may be configured to generate a 3D image of the object based at least on target regions corresponding to the one or more projection images. More descriptions regarding the generation of the 3D image of the object may be found elsewhere in the present disclosure, for example, operation 740 and the descriptions thereof.

It should be noted that the above description of the processing device 140 is merely provided for the purposes of illustration, and not intended to limit the scope of the present disclosure. For persons having ordinary skills in the art, multiple variations and modifications may be made under the teachings of the present disclosure. In some embodiments, the processing device 140 may include one or more additional modules. For example, the processing device 140 may also include a transmission module (not shown) configured to transmit signals (e.g., electrical signals, electromagnetic signals) to one or more components (e.g., the imaging device 110, the one or more terminal devices 130, the storage device 150) of the imaging system 100. As another example, the processing device 140 may include a storage module (not shown) used to store information and/or data (e.g., the one or more projection images the first reconstruction image, the initial range of the target region, the target region, the second reconstruction image, the third reconstruction image, the 3D image) associated with the image reconstruction. In some embodiments, the modules in the processing device 140 may be connected to or communicate with each other via a wired connection or a wireless connection. In some embodiments, two or more of the modules may be combined into a single module, and any one of the modules may be divided into two or more units. For example, the first determination module 620 and the second determination module may be combined as a single module which may both determine the initial range of the target region on the projection image and determine the target region within the initial range on the projection image. However, those variations and modifications do not depart from the scope of the present disclosure.

FIG. 7 is a flowchart illustrating an exemplary process for image reconstruction according to some embodiments of the present disclosure. In some embodiments, process 700 may be executed by the imaging system 100. For example, the process 700 may be implemented as a set of instructions (e.g., an application) stored in a storage device (e.g., the storage device 150, the storage 220, and/or the storage 390). In some embodiments, the processing device 140 (e.g., the processor 210 of the computing device 200, the CPU 340 of the mobile device 300, and/or one or more modules illustrated in FIG. 6) may execute the set of instructions and may accordingly be directed to perform the process 700. The operations of the illustrated process presented below are intended to be illustrative. In some embodiments, the process 700 may be accomplished with one or more additional operations not described and/or without one or more of the operations discussed. Additionally, the order of the operations of process 700 illustrated in FIG. 7 and described below is not intended to be limiting.

In 710, the processing device 140 (e.g., the obtaining module 610 illustrated in FIG. 6, the processor 210 illustrated in FIG. 2) may obtain one or more projection images of an object and a first reconstruction image corresponding to the one or more projection images.

As described in connection with FIG. 1, the object may include a biological object (e.g., a human being, an animal, a plant, or a specific portion, organ, and/or tissue thereof) and/or a non-biological object (e.g., a man-made composition). For example, the object may include a head, a neck, a thorax, a heart, a stomach, a blood vessel, a soft tissue, a tumor, a nodule, a chest, an abdomen, a breast, an intestine, or the like, or any combination thereof. The one or more projection images of the object may refer to projection data and/or images obtained by scanning the object (e.g., the breast) by an imaging device (e.g., the imaging device 110 of the imaging system 100, the DBT device 400 illustrated in FIG. 4).

In some embodiments, the obtaining of the one or more projection images of the object may be done online. For example, the processing device 140 may direct the imaging device 110 or the DBT device 400 to perform a scan on the object and determine the one or more projection images based on scanning data obtained from the imaging device 110 or the DBT device 400. In some embodiments, the obtaining of the one or more projection images of the object may be done offline. For example, the one or more projection images of the object may be previously determined and stored in a storage device (e.g., the storage device 150, the storage 220, the storage 390, an external storage device) or an external system (e.g., a picture archiving and communication system (PACS)), and the processing device 140 may obtain the one or more projection images of the object from the storage device or the external system directly or via a network (e.g., the network 120). For example, the imaging device 110 of the imaging system 100 may perform a scan on the object to generate the one or more projection images of the object. As another example, the DBT device 400 may perform a scan on the object from multiple angles to generate a projection image of the object at each angle. Further, the imaging device 110 or the DBT device 400 may transmit the generated one or more projection images to the storage device for storage, and the processing device 140 may obtain the one or more projection images from the storage device.

The first reconstruction image may include a 3D image including a plurality of image layers. In some embodiments, the processing device 140 may generate the first reconstruction image corresponding to the one or more projection images by reconstructing the one or more projection images based on a reconstruction algorithm. Merely by way of example, the reconstruction algorithm may include filtered back projection (FBP), back projection filtered (BPF), iterative reconstruction, or the like, or any combination thereof. In some embodiments, the first reconstruction image corresponding to the one or more projection images may be previously determined or generated and stored in a storage device (e.g., the storage device 150, the storage 220, the storage 390, an external storage device) or an external system (e.g., a picture archiving and communication system (PACS)). The processing device 140 may obtain the first reconstruction image corresponding to the one or more projection images from the storage device or external system directly or via a network (e.g., the network 120).

In 720, the processing device 140 (e.g., the first determination module 620 illustrated in FIG. 6, the processor 210 illustrated in FIG. 2) may determine, for each of the one or more projection images, an initial range of a target region (also be referred to as a high attenuated region) on the projection image based on the first reconstruction image.

The initial range may refer to an approximate range of the target region. The approximate range may be a region with a degree of coincidence with the target region greater than a threshold (e.g., 90%, 80%, 70%). The target region may refer to a low-gray region (e.g., an artifact region) generated on the projection image by a substance with an X-ray attenuation coefficient greater than a predetermined threshold. In some embodiments, the substance with an X-ray attenuation coefficient greater than the predetermined threshold may be referred to as a high X-ray attenuated substance or a high attenuated substance. Merely by way of example, the high attenuated substance may include a metal implant, a calcification point, a calcification region, or the like, or any combination thereof. The predetermined threshold may be a default setting of the imaging system 100, manually set by a user (e.g., a doctor, a radiologist), or adjusted by the processing device 140 according to actual needs. In some embodiments, the processing device 140 may determine the predetermined threshold based on big data analysis or a trained machine learning model, for example, a trained neural network model. For example, the processing device 140 may determine the predetermined threshold by analyzing X-ray attenuation coefficients of various substances.

In some embodiments, the processing device 140 may generate a maximum density projection image of the first reconstruction image by performing, along a predetermined direction, a maximum density projection on the first reconstruction image. The predetermined direction may be a direction in which a plurality of image layers of the first reconstruction image are superimposed, that is, a direction perpendicular to an extending direction of each image layer of the first reconstruction image, for example, a direction of the Z axis as illustrated in FIG. 4. Specifically, it is assumed that a ray is emitted along the predetermined direction (e.g., the direction of the Z-axis as illustrated in FIG. 4) to pass through the first reconstruction image and project the first reconstruction image to a two-dimensional plane perpendicular to the predetermined direction (e.g., a plane where the X axis and the Y axis are located as illustrated in FIG. 4, a pixel with a largest gray value among pixels of the first reconstruction image that are passed through by the ray may be determined as a pixel of the maximum density projection image of the first reconstruction image.

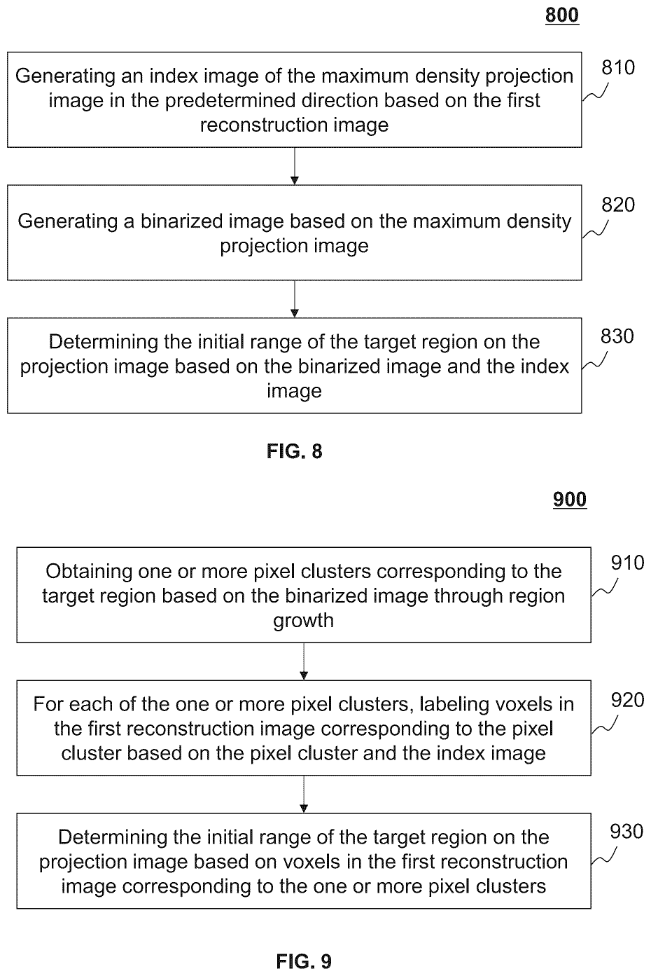

The processing device 140 may determine the initial range of the target region on the projection image based on the maximum density projection image. For example, the processing device 140 may generate an index image of the maximum density projection image in the predetermined direction based on the first reconstruction image and a binarized image based on the maximum density projection image. According to the binarized image and the index image, the processing device 140 may determine the initial range of the target region on the projection image. More descriptions regarding the determination of the initial range of the target region may be found elsewhere in the present disclosure (e.g., FIGS. 8-10 and the description thereof).

In the embodiments of the present disclosure, instead of separately determining an initial range of the target region on each image layer of the first reconstruction image, the maximum density projection is performed on all image layers of the first reconstruction image, and the initial range of the target region is determined based on the generated maximum density projection image, which may reduce the amount of computation while avoiding the impact of in-plane artifacts and out-of-plane artifacts on each image layer of the first reconstruction image on the detection accuracy.

In 730, the processing device 140 (e.g., the second determination module 630 illustrated in FIG. 6, the processor 210 illustrated in FIG. 2) may determine, within the initial range, the target region on the projection image.

In some embodiments, the processing device 140 may perform a bilateral filter on the initial range on the projection image to remove noise. Further, the processing device 140 may detect the initial range on the projection image to obtain seed points of the target region. In some embodiments, the processing device 140 may extract pixels in the initial range on the projection image with gray values less than a certain gray threshold as the seed points of the target region (which may be referred to as projection image thresholding for brevity). In some embodiments, the processing device 140 may obtain a relative gradient image of the initial range on the projection image, and extract pixels in the relative gradient image with gradient values exceeding a certain gradient threshold as the seed points of the target region (which may be referred to as relative gradient image thresholding for brevity). Merely by way of example, the processing device 140 may perform a derivation on the initial range on the projection image based on image grays to determine the relative gradient image of the initial range on the projection image. In some embodiments, combining the projection image thresholding and the relative gradient image thresholding, the processing device 140 may extract the pixels in the initial range on the projection image with gray values less the certain gray threshold and pixels in the relative gradient image with gradient values exceeding the certain gradient threshold as the seed points of the target region. In some embodiments, the gray threshold and/or the gradient threshold may be default settings of the imaging system 100, manually set by a user (e.g., a doctor, a radiologist), or adjusted by the processing device 140 according to actual needs. In some embodiments, the processing device 140 may determine the gray threshold and/or the gradient threshold based on big data analysis or a trained machine learning model, for example, a trained neural network model.

In some embodiments, the processing device 140 may obtain the seed points based on a portion of the first reconstruction image corresponding to the initial range on the projection image. For example, the processing device 140 may perform preprocessing (e.g., filtering) on the portion of the first reconstruction image corresponding to the initial range on the projection image, and then extract pixels in the portion of the first reconstruction image corresponding to the initial range on the projection image with gray values less a certain gray threshold, and further project the pixels on the projection image along an incident direction of rays that is used for obtaining the projection image. Further, the processing device 140 may designate projection points of the pixels as the seed point of the target region. In some alternative embodiments, the processing device 140 may determine coincident points of the projection points and the extracted pixels during the projection image thresholding and/or the extracted pixels during the relative gradient image thresholding as the seed point of the target region.

In some embodiments, according to the above-obtained seed points of the target region, the processing device 140 may determine and/or remove (or segment) the target region in the initial range on the projection image through region growth. The region growth refers to a process of expanding each seed point into a region. For example, by the region growth, adjacent pixels of each seed point that have similar properties, such as intensity, gray level, texture color, etc., may be merged together as a region. In some embodiments, according to the above-obtained seed points, the processing device 140 may determine and/or remove (or segment) the target region in the initial range on the projection image by using a trained machine learning model. For example, the processing device 140 may input the above-obtained seed points into the trained machine learning model and determine a region based on the output of the trained machine learning model. In some embodiments, the processing device 140 may designate the determined region as the target region. In some embodiments, the processing device 140 may update the determined region based on a contrast signal-to-noise ratio of pixels in the projection image, and designate the updated region as the target region. For example, the processing device 140 may incorporate pixels in the projection image with a CNR greater than a certain CNR threshold into the determined region to update the determined region. The CNR threshold may be a default setting of the imaging system 100, manually set by a user (e.g., a doctor, a radiologist), or adjusted by the processing device 140 according to actual needs. In some embodiments, the processing device 140 may determine the CNR threshold based on big data analysis or a trained machine learning model, for example, a trained neural network model. In some embodiments, the processing device 140 may determine and/or remove (or segment) the target region in the initial range on the projection image by using other manners known in the art.

Generally, the removal (or segmentation) of the target region is performed directly on the projection image or the first reconstruction image. After the target region is removed (or segmented), an interpolation operation is performed. Since the interpolation operation is performed on the projection image, the removal (or segmentation) of the target region that is performed on the projection image has a sufficiently precise edge, thereby improving the accuracy and precision of the removal (or segmentation) of the artifacts of the high attenuated substance. However, a radiation dose of a TOMO system (e.g., the imaging system 100) when obtaining the projection image is relatively low, which leads to a relatively large noise in the projection image, which is not conducive to the removal (or segmentation) of the target region in the projection image. In addition, since X-ray attenuation coefficients of bones, dense tissues, etc. are also relatively large, the target region is not necessarily the region with a largest gray and/or a largest gradient in the projection image, which may reduce the accuracy of the removal (or segmentation) of the target region in the projection image. Since information of the one or more projection images is integrated into the first reconstruction image, the first reconstruction image includes richer information of the high attenuated substance. In addition, since the first reconstruction image undergoes a filtering operation during the reconstruction process, the noise of the first reconstruction image is lower than that of the projection image, which is conducive to the removal (or segmentation) of the target region. However, there are various artifacts in the first reconstruction image, which reduce the accuracy of the removal (or segmentation) of the target region, thereby resulting in some artifacts of the high attenuated substance still present in the subsequently generated 3D images.

According to the embodiments of the present disclosure, a coarse localization (i.e., the initial range) of the target region may be determined based on the first reconstruction image, and the target region may be further determined on the projection image based on the coarse localization, which combines the above-mentioned advantage of removing (or segmenting) the target region on the first reconstruction image and the projection image, thereby improving the accuracy of removing (or segmenting) the target region and the removal effect of the artifacts of the high attenuated substance.

In 740, the processing device 140 (e.g., the generation module 640 illustrated in FIG. 6, the processor 210 illustrated in FIG. 2) may generate a 3D image of the object based at least on target regions corresponding to the one or more projection images.

The 3D image of the object may refer to an image of the object from which the artifacts of the high attenuated substance have been removed. In some embodiments, the processing device 140 may process the projection image by removing the target region from the projection image and generate the 3D image of the object based on the target regions corresponding to the one or more projection images and one or more processed projection images and/or the one or more projection images. Specifically, the processing device 140 may determine a second reconstruction image by reconstructing the target regions corresponding to the one or more projection images. For example, the processing device 140 may perform a back projection on the target regions corresponding to the one or more projection images to obtain the second reconstruction image. For each of the one or more processed projection images, the processing device 140 may interpolate a region on the processed projection image corresponding to the target region. The interpolation of the region may include a linear interpolation, a nonlinear interpolation, a cubic spline interpolation, a polynomial fit interpolation, or the like, or any combination thereof. The processing device 140 may determine a third reconstruction image by reconstructing one or more interpolated projection images. For example, the processing device 140 may reconstruct the one or more interpolated projection images based on a reconstruction algorithm. Merely by way of example, the reconstruction algorithm may include filtered back projection (FBP), back projection filtered (BPF), iterative reconstruction, or the like, or any combination thereof. Further, the processing device 140 may generate the 3D image of the object based on the second reconstruction image and the third reconstruction image and/or the one or more projection images. For example, the processing device 140 may fuse the second reconstruction image with the one or more projection images to generate the 3D image of the object. As another example, the processing device 140 may fuse the second reconstruction image and the third reconstruction image to generate the 3D image of the object. As a further example, the processing device 140 may fuse the second reconstruction image, the one or more projection images, and the third reconstruction image to generate the 3D image of the object.

It should be noted that the above description of the process 700 is merely provided for the purposes of illustration, and not intended to limit the scope of the present disclosure. For persons having ordinary skills in the art, multiple variations or modifications may be made under the teachings of the present disclosure. In some embodiments, the process 700 may be accomplished with one or more additional operations not described and/or without one or more of the operations discussed above. For example, the process 700 may include an additional transmitting operation in which the processing device 140 may transmit the 3D image of the object to a terminal device (e.g., the terminal device 130 of a doctor) for display. As another example, the process 700 may include an additional storing operation in which the processing device 140 may store information and/or data (e.g., the one or more projection images, the first reconstruction image, the initial range of the target region, the target region, the second reconstruction image, the third reconstruction image, the 3D image) associated with the image reconstruction in a storage device (e.g., the storage device 150, the storage 220, the storage 390) disclosed elsewhere in the present disclosure. However, those variations and modifications do not depart from the scope of the present disclosure.

FIG. 8 is a flowchart illustrating an exemplary process for determining an initial range of a target region on a projection image according to some embodiments of the present disclosure. In some embodiments, process 800 may be executed by the imaging system 100. For example, the process 800 may be implemented as a set of instructions (e.g., an application) stored in a storage device (e.g., the storage device 150, the storage 220, and/or the storage 390). In some embodiments, the processing device 140 (e.g., the processor 210 of the computing device 200, the CPU 340 of the mobile device 300, and/or one or more modules illustrated in FIG. 6) may execute the set of instructions and may accordingly be directed to perform the process 800. The operations of the illustrated process presented below are intended to be illustrative. In some embodiments, the process 800 may be accomplished with one or more additional operations not described and/or without one or more of the operations discussed. Additionally, the order of the operations of process 800 illustrated in FIG. 8 and described below is not intended to be limiting.

In 810, the processing device 140 (e.g., the first determination module 620 illustrated in FIG. 6, the processor 210 illustrated in FIG. 2) may generate an index image of a maximum density projection image in a predetermined direction based on a first reconstruction image.

As described in connection with FIG. 7, the predetermined direction may be a direction in which a plurality of image layers of the first reconstruction image are superimposed, that is, a direction perpendicular to an extending direction of each image layer of the first reconstruction image, for example, a direction of the Z axis as illustrated in FIG. 4. The index image may include index values. The index values may indicate positions, on the first reconstruction image, of pixels on the maximum density projection image. For example, an index value may be a coordinate, on the first reconstruction image along the predetermined direction, of a pixel on the maximum density projection image, and the index value may indicate which image layer of the first reconstructed image the pixel on the maximum density projection image comes from. In some embodiments, for each of the pixels on the maximum density projection image, the processing device 140 may obtain a position of the pixel on the first reconstructed image. Further, the processing device 140 may generate an index image of the maximum density projection image in the predetermined direction based on positions of the pixels on the maximum density projection image.

In 820, the processing device 140 (e.g., the first determination module 620 illustrated in FIG. 6, the processor 210 illustrated in FIG. 2) may generate a binarized image based on the maximum density projection image.

The binarized image may refer to an image in which two values (e.g., 0 and 1, 0 and 255) represent grayscale values of pixels in the image. In some embodiments, the processing device 140 may generate the binarized image based on a grayscale threshold and the maximum density projection image. The grayscale threshold may be a default setting of the imaging system 100, manually set by a user (e.g., a doctor, a radiologist), or adjusted by the processing device 140 according to actual needs. In some embodiments, the processing device 140 may determine the grayscale threshold based on big data analysis or a trained machine learning model, for example, a trained neural network model. In some embodiments, for each pixel in the maximum density projection image, the processing device 140 may determine whether a gray value of the pixel is greater or equal to (or less than) the grayscale threshold and generate the binarized value image based on the determination result of whether the gray value of the pixel is greater (or less than) the grayscale threshold. For example, if the gray value of the pixel is greater than or equal to (or less than) the grayscale threshold, the processing device 140 may set a value of the pixel to 1 in the binarized image; if the gray value of the pixel is less than (or greater than or equal to) the grayscale threshold, the processing device 140 may set the value of the pixel to 0 in the binarized image.

In some embodiments, the processing device 140 may generate a relative gradient image of the maximum density projection image. Merely by way of example, the processing device 140 may generate the relative gradient image of the maximum density projection image by performing a derivation on the maximum density projection image. Further, the processing device 140 may generate the binarized image based on a gradient threshold and the relative gradient image. The gradient threshold may be a default setting of the imaging system 100, manually set by the user (e.g., a doctor, a radiologist), or adjusted by the processing device 140 according to actual needs. In some embodiments, the processing device 140 may determine the gradient threshold based on big data analysis or a trained machine learning model, for example, a trained neural network model. In some embodiments, for each pixel in the relative gradient image, the processing device 140 may determine whether a gradient value of the pixel is greater than or equal to (or less than) the gradient threshold, and generate the binarized image based on a determination result of whether the gradient value of the pixel is greater than or equal to (or less than) the gradient threshold. For example, if the gradient value of the pixel is greater than or equal to (or less than) the gradient threshold, the processing device 140 may set a value of the pixel to 1 in the binarized image; if the gradient value of the pixel is less than (or greater than or equal to) the gradient threshold, the processing device 140 set the value of the pixel to 0 in the binarized image. A gradient value of a pixel in the relative gradient image may indicate a gray change rate of the pixel in the relative gradient image relative to adjacent pixels of the pixel. Generally, regions with more pronounced artifacts of a high attenuated substance have higher gradient values. The binarized image is generated based on the gradient threshold and the relative gradient image, which optimizes a correlation between the generation of the binarized image and the artifacts of the high attenuated substance, so that the determination of the initial range of the target region is more closely related to the removal (or segmentation) of the artifacts of the high attenuated substance.

In some embodiments, the processing device 140 may designate the above-mentioned binarized image generated based on the grayscale threshold and the maximum density projection image as an initial binarized image. Further, the processing device 140 may generate the binarized image by updating the initial binarized image based on the gradient threshold and the relative gradient image. For example, for each pixel with a value of 1 in the initial binarized image, the processing device 140 may determine whether a gradient value of the pixel in the relative gradient image is greater than or equal to the gradient threshold, and update the initial binarized image based on a determination result of whether the gradient value of the pixel in the relative gradient image is greater than the gradient threshold. Specifically, if the gradient value of the pixel in the relative gradient image is greater than or equal to the gradient threshold, the processing device 140 may keep the value of the pixel as 1 in the binarized image; if the gradient value of the pixel in the relative gradient image is less than the gradient threshold, the processing device 140 may update the value of the pixel to 0 in the binarized image.

In 830, the processing device 140 (e.g., the first determination module 620 illustrated in FIG. 6, the processor 210 illustrated in FIG. 2) may determine the initial range of the target region on the projection image based on the binarized image and the index image.

In some embodiments, the processing device 140 may obtain one or more pixel clusters corresponding to the target region based on the binarized image through region growth. For each of the one or more pixel clusters, the processing device 140 may label voxels in the first reconstruction image corresponding to the pixel cluster based on the pixel cluster and the index image. Further, the processing device 140 may determine the initial range of the target region on the projection image based on voxels in the first reconstruction image corresponding to the one or more pixel clusters. More descriptions regarding the determination of the initial range of the target region may be found elsewhere in the present disclosure (e.g., FIG. 9 and the description thereof).

It should be noted that the above description of the process 800 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 9 is a flowchart illustrating an exemplary process for determining an initial range of a target region on a projection image according to some embodiments of the present disclosure. In some embodiments, process 900 may be executed by the imaging system 100. For example, the process 900 may be implemented as a set of instructions (e.g., an application) stored in a storage device (e.g., the storage device 150, the storage 220, and/or the storage 390). In some embodiments, the processing device 140 (e.g., the processor 210 of the computing device 200, the CPU 340 of the mobile device 300, and/or one or more modules illustrated in FIG. 6) may execute the set of instructions and may accordingly be directed to perform the process 900. The operations of the illustrated process presented below are intended to be illustrative. In some embodiments, the process 900 may be accomplished with one or more additional operations not described and/or without one or more of the operations discussed. Additionally, the order of the operations of process 900 illustrated in FIG. 9 and described below is not intended to be limiting.

In 910, the processing device 140 (e.g., the first determination module 620 illustrated in FIG. 6, the processor 210 illustrated in FIG. 2) may obtain one or more pixel clusters corresponding to the target region based on a binarized image through region growth.

A pixel cluster may refer to a collection of multiple pixels. As described in connection with operation 720 in FIG. 7, gray values of pixels in the binarized image may be represented as 0 and 1. In some embodiments, for any one pixel A in the binarized image with a gray value of 1, the processing device 140 may group the pixel A and other surrounding pixels of the pixel A with a gray value of 1 into a same group. Further, for each of other pixels in the group except the pixel A, the processing device 140 may group other surrounding pixels of the pixel with a gray value of 1 into the group, until there is no pixel with a gray value of 1 around each pixel in the group, the region growth may be stopped, and the processing device 140 may regard the group as a pixel cluster. The processing device 140 may perform region growth on a pixel in the binarized image whose gray value is 1 and does not belong to any one pixel cluster, until all the pixels in the binarized image whose gray value is 1 are grouped into corresponding pixel clusters, and then the processing device 140 may stop the region growth and obtain the above-mentioned one or more pixel clusters.

In 920, the processing device 140 (e.g., the first determination module 620 illustrated in FIG. 6, the processor 210 illustrated in FIG. 2) may label, for each of the one or more pixel clusters, voxels in a first reconstruction image corresponding to the pixel cluster based on the pixel cluster and an index image.

As described in connection with operation 810 in FIG. 8, the index image may include index values each of which may be a coordinate, on the first reconstruction image along a predetermined direction (e.g., a direction of a Z axis illustrated in FIG. 4), of a pixel on a maximum density projection image. In some embodiments, for each of the one or more pixel clusters, the processing device 140 may perform a histogram statistic on index values in the index image corresponding to pixels in the pixel cluster. For example, the processing device 140 may obtain a histogram with the index value as the abscissa and the number of pixels as the ordinate. The processing device 140 may obtain an index value range corresponding to the pixels of the pixel cluster based on the histogram statistics. In some embodiments, the processing device 140 may obtain at least one peak satisfying a certain condition from the histogram obtained by the histogram statistic, and obtain the index value range corresponding to the pixels of the pixel cluster based on the at least one peak satisfying the certain condition. Merely by way of example, the certain condition may include that an ordinate (i.e., the number of pixels) of a peak exceeds a certain threshold (e.g., 100, 200, 500), an arrangement number of a peak is greater than a certain threshold when all peaks are arranged in descending order of height, etc. For example, assuming that there are three peaks satisfying the certain condition in the histogram obtained by the histogram statistic, according to abscissas of the three peaks, the processing device 140 may obtain index values (e.g., 48, 49, and 50) corresponding to the three peaks. Further, the processing device 140 may designate a range (e.g., 48-50) between a minimum value and a maximum value among the index values corresponding to the three peaks as the index value range corresponding to the pixels of the pixel cluster. The processing device 140 may update the pixel cluster based on the index value range corresponding to the pixels of the pixel cluster. For example, the processing device 140 may remove, from the pixel cluster, pixels whose index values are not within the index value range. According to the index value range corresponding to pixels in the updated pixel cluster, the processing device 140 may label voxels in the first reconstructed image corresponding to the updated pixel cluster. As described in connection with operation 810 in FIG. 8, the index value may indicate which image layer of the first reconstructed image the pixel on the maximum density projection image comes from. Therefore, according to the index value range corresponding to the pixels in the updated pixel cluster, the processing device 140 may obtain which image layers (e.g., image layers with Z-axis coordinates 48-50) of the first reconstructed image the pixels in the updated pixel cluster come from. For each of pixels in the updated pixel cluster, the processing device 140 may label, in the first reconstruction image, three-dimensional coordinates of voxels corresponding to the pixel based on X-axis and Y-axis coordinates of the pixel in the maximum density projection image and the index value (i.e., the image layer).

In 930, the processing device 140 (e.g., the first determination module 620 illustrated in FIG. 6, the processor 210 illustrated in FIG. 2) may determine the initial range of the target region on the projection image based on voxels in the first reconstruction image corresponding to the one or more pixel clusters. In some embodiments, for a specific projection image, the processing device 140 may project the voxels corresponding to one or more pixel clusters along an incident direction of rays that are used for obtaining the projection image to obtain the initial range of the target region on the projection image (which also referred to as orthographic projection).

It should be noted that the above description of the process 900 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

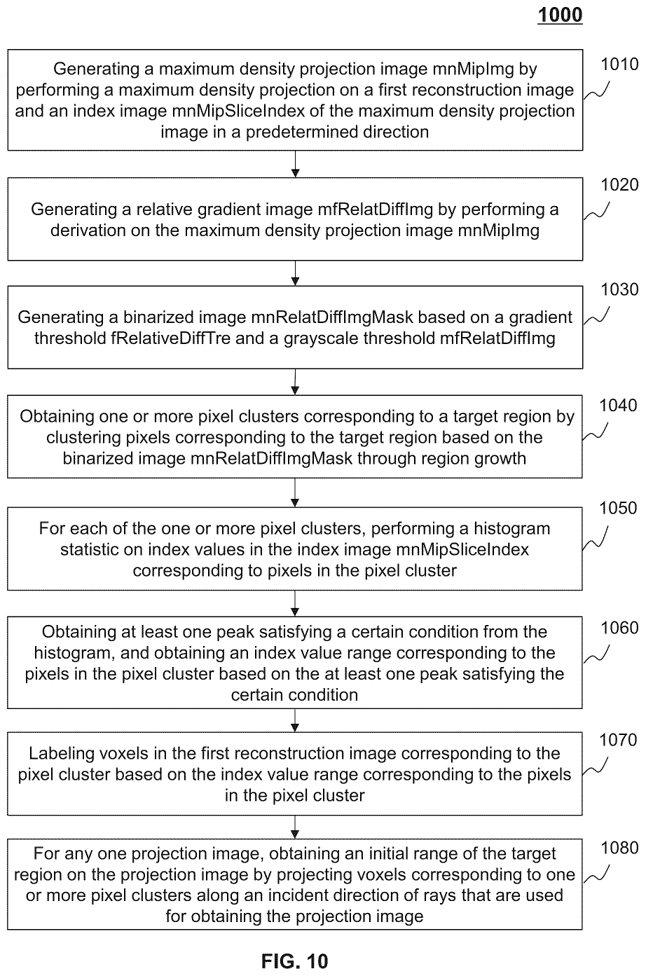

FIG. 10 is a flowchart illustrating an exemplary process for determining an initial range of a target region on a projection image according to some embodiments of the present disclosure. In some embodiments, process 1000 may be executed by the imaging system 100. For example, the process 1000 may be implemented as a set of instructions (e.g., an application) stored in a storage device (e.g., the storage device 150, the storage 220, and/or the storage 390). In some embodiments, the processing device 140 (e.g., the processor 210 of the computing device 200, the CPU 340 of the mobile device 300, and/or one or more modules illustrated in FIG. 6) may execute the set of instructions and may accordingly be directed to perform the process 1000. The operations of the illustrated process presented below are intended to be illustrative. In some embodiments, the process 1000 may be accomplished with one or more additional operations not described and/or without one or more of the operations discussed. Additionally, the order of the operations of process 1000 illustrated in FIG. 10 and described below is not intended to be limiting.

In 1010, the processing device 140 (e.g., the first determination module 620 illustrated in FIG. 6, the processor 210 illustrated in FIG. 2) may generate a maximum density projection image mnMipImg by performing a maximum density projection on a first reconstruction image and an index image mnMipSliceIndex of the maximum density projection image in a predetermined direction (e.g., the direction of the Z-axis as illustrated in FIG. 4). In some embodiments, the generation of the maximum density projection image mnMiplmg may be performed in a similar manner as described in connection with operation 720 in FIG. 7, and the descriptions thereof are not repeated here. In some embodiments, the generation of the index image mnMipSliceIndex may be performed in a similar manner as described in connection with operation 810 in FIG. 8, and the descriptions thereof are not repeated here.

In 1020, the processing device 140 (e.g., the first determination module 620 illustrated in FIG. 6, the processor 210 illustrated in FIG. 2) may generate a relative gradient image mfRelatDiffImg by performing a derivation on the maximum density projection image mnMiplmg.

In 1030, the processing device 140 (e.g., the first determination module 620 illustrated in FIG. 6, the processor 210 illustrated in FIG. 2) may generate a binarized image mnRelatDiffImgMask based on a gradient threshold fRelativeDiffTre and a grayscale threshold mfRelatDiffImg. In some embodiments, the generation of the binarized image mnRelatDiffImgMask may be performed in a similar manner as described in connection with operation 820 in FIG. 8, and the descriptions thereof are not repeated here.

In 1040, the processing device 140 (e.g., the first determination module 620 illustrated in FIG. 6, the processor 210 illustrated in FIG. 2) may obtain one or more pixel clusters corresponding to the target region by clustering pixels corresponding to the target region based on the binarized image mnRelatDiffImgMask through region growth. In some embodiments, the obtaining of the one or more pixel clusters corresponding to the target region may be performed in a similar manner as described in connection with operation 910 in FIG. 9, and the descriptions thereof are not repeated here. In some embodiments, it is assumed that there are n pixel clusters corresponding to the target region, and n is greater than or equal to 1.

In 1050, for each of the one or more pixel clusters (e.g., n pixel clusters), the processing device 140 (e.g., the first determination module 620 illustrated in FIG. 6, the processor 210 illustrated in FIG. 2) may perform a histogram statistic on index values in the index image mnMipSliceIndex corresponding to pixels in the pixel cluster. In some embodiments, the processing device 140 may perform the histogram statistic on the index values corresponding to the pixels in the pixel cluster with the index values as an abscissa and the number of the pixels as an ordinate to obtain a histogram.

In 1060, the processing device 140 (e.g., the first determination module 620 illustrated in FIG. 6, the processor 210 illustrated in FIG. 2) may obtain at least one peak satisfying a certain condition from the histogram, and obtain an index value range corresponding to the pixels in the pixel cluster based on the at least one peak satisfying the certain condition. In some embodiments, the obtaining of the index value range corresponding to the pixels of the pixel cluster may be performed in a similar manner as described in connection with operation 920 in FIG. 9, and the descriptions thereof are not repeated here.

In 1070, the processing device 140 (e.g., the first determination module 620 illustrated in FIG. 6, the processor 210 illustrated in FIG. 2) may label voxels in the first reconstruction image corresponding to the pixel cluster based on the index value range corresponding to the pixels in the pixel cluster. In some embodiments, the labeling of the voxels corresponding to the pixel cluster may be performed in a similar manner as described in connection with operation 920 in FIG. 9, and the descriptions thereof are not repeated here.

In 1080, for any one projection image, the processing device 140 (e.g., the first determination module 620 illustrated in FIG. 6, the processor 210 illustrated in FIG. 2) may obtain the initial range of the target region on the projection image by projecting voxels corresponding to one or more pixel clusters along an incident direction of rays that are used for obtaining the projection image.

It should be noted that the above description of the process 1000 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.), or combining software and hardware implementation that may all generally be referred to herein as a “unit,” “module,” or “system.” Furthermore, aspects of the present disclosure may take the form of a computer program product embodied in one or more computer-readable media having computer-readable program code embodied thereon.

A computer-readable signal medium may include a propagated data signal with computer-readable program code embodied therein, for example, in a baseband or as part of a carrier wave. Such a propagated signal may take any of a variety of forms, including electromagnetic, optical, or the like, or any suitable combination thereof. A computer-readable signal medium may be any computer-readable medium that is not a computer-readable storage medium and that may communicate, propagate, or transport a program for use by or in connection with an instruction-performing system, apparatus, or device. Program code embodied on a computer-readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python, or the like, conventional procedural programming languages, such as the “C” programming language, Visual Basic, Fortran 2103, Perl, COBOL 2102, PHP, ABAP, dynamic programming languages such as Python, Ruby, and Groovy, or other programming languages. The program code may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A system, comprising:
at least one storage device including a set of instructions; and
at least one processor in communication with the at least one storage device, wherein when executing the set of instructions, the at least one processor causes the system to perform operations including:
obtaining one or more projection images of an object and a first reconstruction image corresponding to the one or more projection images;
for each of the one or more projection images,
determining an initial range of a target region on the projection image based on the first reconstruction image, the target region being a low-gray region generated on the projection image by a substance with an X-ray attenuation coefficient greater than a predetermined threshold;
determining, within the initial range, the target region on the projection image; and
generating a three-dimensional (3D) image of the object based at least on target regions corresponding to the one or more projection images.

2. The system of claim 1, wherein the determining the initial range of the target region on the projection image based on the first reconstruction image includes:
generating a maximum density projection image of the first reconstruction image by performing, along a predetermined direction, a maximum density projection on the first reconstruction image; and
determining the initial range of the target region on the projection image based on the maximum density projection image.

3. The system of claim 2, wherein the determining the initial range of the target region on the projection image based on the maximum density projection image includes:
generating an index image of the maximum density projection image in the predetermined direction based on the first reconstruction image, the index image including index values, the index values indicating positions, on the first reconstruction image, of pixels on the maximum density projection image;
generating a binarized image based on the maximum density projection image; and
determining the initial range of the target region on the projection image based on the binarized image and the index image.

4. The system of claim 3, wherein the generating the binarized image based on the maximum density projection image includes:
generating the binarized image based on a grayscale threshold and the maximum density projection image.

5. The system of claim 3, wherein the generating the binarized image based on the maximum density projection image includes:
generating a relative gradient image of the maximum density projection image; and
generating the binarized image based on a gradient threshold and the relative gradient image.

6. The system of claim 5, wherein the generating the binarized image based on the gradient threshold and the relative gradient image includes:
generating an initial binarized image based on a grayscale threshold and the maximum density projection image; and
generating the binarized image by updating the initial binarized image based on the gradient threshold and the relative gradient image.

7. The system of claim 3, wherein the determining the initial range of the target region on the projection image based on the binarized image and the index image includes:
obtaining one or more pixel clusters corresponding to the target region based on the binarized image through region growth;
for each of the one or more pixel clusters, labeling voxels in the first reconstruction image corresponding to the pixel cluster based on the pixel cluster and the index image; and
determining the initial range of the target region on the projection image based on voxels in the first reconstruction image corresponding to the one or more pixel clusters.

8. The system of claim 7, wherein for each of the one or more pixel clusters, the labeling the voxels in the first reconstruction image corresponding to the pixel cluster based on the pixel cluster and the index image includes:
performing a histogram statistic on index values in the index image corresponding to pixels in the pixel cluster;
obtaining an index value range corresponding to the pixels of the pixel cluster based on the histogram statistic; and
labeling the voxels in the first reconstruction image corresponding to the pixel cluster based on the index value range.

9. The system of claim 7, wherein the determining the initial range of the target region on the projection image based on the voxels in the first reconstruction image corresponding to the one or more pixel clusters includes:
obtaining the initial range of the target region on the projection image by projecting the voxels in the first reconstruction image corresponding to the one or more pixel clusters on the projection image along an incident direction of rays associated with the obtaining of the projection image.

10. The system of claim 1, wherein
the operations further include processing the projection image by removing the target region from the projection image, and
the generating the 3D image of the object based at least on the target regions corresponding to the one or more projection images includes generating the 3D image of the object based on the target regions corresponding to the one or more projection images and one or more processed projection images or the one or more projection images.

11. The system of claim 10, wherein the generating the 3D image of the object based on the target regions corresponding to the one or more projection images and the at least one of the one or more processed projection images or the one or more projection images includes:
determining a second reconstruction image by reconstructing the target regions corresponding to the one or more projection images;
for each of the one or more processed projection images, interpolating a region on the processed projection image corresponding to the target region;
determining a third reconstruction image by reconstructing one or more interpolated projection images; and
generating the 3D image of the object based on the second reconstruction image and the third reconstruction image or the one or more projection images.

12. The system of claim 1, wherein the one or more projection images are obtained by a digital breast tomosynthesis device.

13. A method for image reconstruction, the method being implemented on a computing device including at least one processor and at least one storage device, the method comprising:
obtaining one or more projection images of an object and a first reconstruction image corresponding to the one or more projection images;
for each of the one or more projection images,
determining an initial range of a target region on the projection image based on the first reconstruction image, the target region being a low-gray region generated on the projection image by a substance with an X-ray attenuation coefficient greater than a predetermined threshold;
determining, within the initial range, the target region on the projection image; and
generating a three-dimensional (3D) image of the object based at least on target regions corresponding to the one or more projection images.

14. The method of claim 13, wherein the determining the initial range of the target region on the projection image based on the first reconstruction image includes:
generating a maximum density projection image of the first reconstruction image by performing, along a predetermined direction, a maximum density projection on the first reconstruction image; and
determining the initial range of the target region on the projection image based on the maximum density projection image.

15. The method of claim 14, wherein the determining the initial range of the target region on the projection image based on the maximum density projection image includes:
generating an index image of the maximum density projection image in the predetermined direction based on the first reconstruction image, the index image including index values, the index values indicating positions, on the first reconstruction image, of pixels on the maximum density projection image;
generating a binarized image based on the maximum density projection image; and
determining the initial range of the target region on the projection image based on the binarized image and the index image.

16. The method of claim 15, wherein the generating the binarized image based on the maximum density projection image includes:
generating the binarized image based on a grayscale threshold and the maximum density projection image.

17. The method of claim 15, wherein the generating the binarized image based on the maximum density projection image includes:
generating a relative gradient image of the maximum density projection image; and
generating the binarized image based on a gradient threshold and the relative gradient image.

18. The method of claim 17, wherein the generating the binarized image based on the gradient threshold and the relative gradient image includes:
generating an initial binarized image based on a grayscale threshold and the maximum density projection image; and
generating the binarized image by updating the initial binarized image based on the gradient threshold and the relative gradient image.

19. The method of claim 15, wherein the determining the initial range of the target region on the projection image based on the binarized image and the index image includes:
obtaining one or more pixel clusters corresponding to the target region based on the binarized image through region growth;
for each of the one or more pixel clusters, labeling voxels in the first reconstruction image corresponding to the pixel cluster based on the pixel cluster and the index image; and
determining the initial range of the target region on the projection image based on voxels in the first reconstruction image corresponding to the one or more pixel clusters.

20. A non-transitory computer readable medium, comprising executable instructions that, when executed by at least one processor, direct the at least one processor to perform a method, the method comprising:
obtaining one or more projection images of an object and a first reconstruction image corresponding to the one or more projection images;
for each of the one or more projection images,
determining an initial range of a target region on the projection image based on the first reconstruction image, the target region being a low-gray region generated on the projection image by a substance with an X-ray attenuation coefficient greater than a predetermined threshold;
determining, within the initial range, the target region on the projection image; and
generating a three-dimensional (3D) image of the object based at least on target regions corresponding to the one or more projection images.
